(19) United States
(12) Patent Application Publication
(10) Pub. No.: US 2007/0284436 A1
(43) Pub. Date: Dec. 13, 2007

(54) Credit card payment system

(76) Inventor: Micah Alexander Gland, Helsinki (FI)

Correspondence Address: YOUNG & THOMPSON, 745 SOUTH 23RD STREET, 2ND FLOOR, ARLINGTON, VA, 22202, US

(21) Appl. No.: 11/447,961

(22) Filed: Jun. 7, 2006

(51) Int. Cl. G06K 5/00; G06Q 40/00

(52) U.S. Cl. 235/380; 705/44

(57) ABSTRACT

A credit card payment system that utilizes a secondary credit card identity to safely intercept a transaction authorization request between the credit card accepter and the issuing bank to a network element of a service provider. Advantageously an additional transaction confirmation is performed directly with the credit card holder. The service provider maintains a database system that includes a control record for storing control information that controls the credit card control procedure in the service procedure. The service provider also provides a user interface that is accessible over a user network. Through this user interface the credit card holder is able to interactively manage the control information and thus the operations during authentication procedures. An advantage of the method and arrangement of the invention is that it improves the safety of the credit card payment system and provides improved user control to the credit card payment operations.

### FIELD OF THE INVENTION

The present invention relates to credit card payments, and more particularly to a credit card payment system, a method for conducting credit card payments, a network element, and a computer program product according to the preambles of the independent claims.

### BACKGROUND OF THE INVENTION

Credit card usage in electronic commerce has not reached its saturation point and one of the main reasons is the fear of abuse of credit card information. The credit card companies have tried to mitigate the problem by introducing various security mechanisms to the payment processes. As a result, the security of transactions has greatly improved but due to the technical knowledge required to understand the improvement they have been of little comfort to the consumers. The problems with eavesdropping and computer hijacking have come up lately in many occasions, and also the subject of credit card misusage on the Internet has been dealt extensively in the media. Due to this the call for caution has recently overblown causing the consumers to avoid any credit card transactions over the Internet.

Many credit card holders believe that efficient security procedures for securing the transfer of credit card information already exist, but they do not trust themselves to be able to recognize a reliable arrangement for submitting the credit card information from a bogus one. In order to avoid risks they thus categorically avoid any credit card transactions.

Furthermore, the procedure is very invisible, and when dealing with a new and/or somewhat less known merchant, the credit card holders do not feel comfortable, even if the merchant duly acknowledges the transaction. Presently some of the issuing banks update the credit card charges to the statement very quickly such that they may be reviewed in the statement in secure web pages. However, there are still great many people that do not yet control their bills online, but wait until the paper bill is posted in the mail. Accordingly, after submitting the credit card information to the merchant the user has no visibility or control to the transaction before it appears to his or her account statement. Since this period may be long and varies out of control of the user, whereas the dubious players are known to operate quickly, the payment system is still considered doubtful.

The fundamental principle in operations of the relevant parties is safety and security, and therefore the procedures and interfaces between the authenticating parties are more or less closed and sensitive for any kind of deviations from the carefully specified operating procedures. Considering the extensive installed base, the huge number of daily credit card operations globally, and the above prioritization, it is not very likely that existing credit card payment systems will undergo any essential alterations for the purpose of improving the user experience of the credit card holders in electronic commerce.

### BRIEF DESCRIPTION OF THE INVENTION

An object of the present invention is thus to provide a solution so as to alleviate the above disadvantages. The objects of the invention are achieved by a credit card payment system, a method for conducting credit card payments, a network element, and a computer program product, which are characterized by what is stated in the independent claims. The preferred embodiments of the invention are disclosed in the dependent claims.

The invention is based on the idea utilizing a secondary credit card identity to safely intercept a transaction authorization request between the credit card accepter and the issuing bank to a network element of a service provider. Advantageously an additional transaction confirmation is performed directly with the credit card holder. The service provider maintains a database system that includes a control record for storing control information that controls the credit card control procedure in the service procedure. The service provider also maintains a user interface that is accessible over a user network. This user interface allows the credit card holder to manage said control information.

An advantage of the method and arrangement of the invention is that it enhances the security of the credit card payment system, and adds the visibility and controllability of credit card payment transactions without causing essential changes to the existing protocols between the parties involved in authorization operations.

### BRIEF DESCRIPTION OF THE DRAWINGS

In the following the invention will be described in greater detail by means of preferred embodiments with reference to the attached drawings, in which

FIG. 1 provides a simplified illustration of parties for executing a credit card payment;

FIG. 2 illustrates an exemplary network configuration;

FIG. 3 illustrates operation of the credit card system of FIGS. 1 and 2;

FIG. 4 illustrates operation of the service provider;

FIG. 5 illustrates the functions of the service provider when it operates as a user interface; and

FIG. 6 illustrates the functional architecture of a network element.

### DETAILED DESCRIPTION OF THE INVENTION

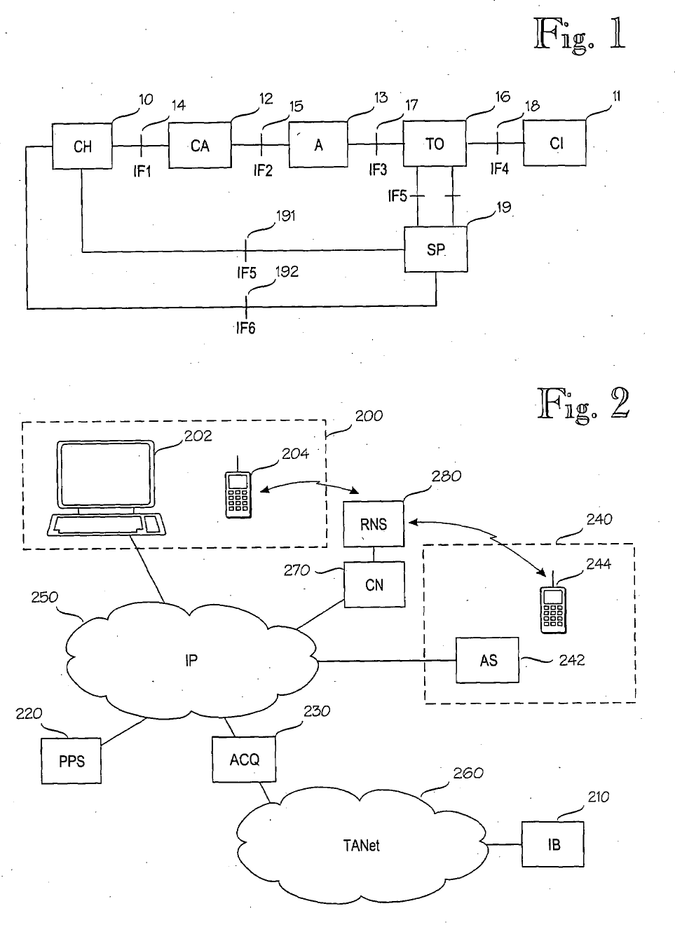

The block chart of FIG. 1 provides a simplified illustration of parties for executing a credit card payment according to an embodiment of the present invention. Credit card in this context refers to identification means that facilitate execution of a contractual relationship established between a card holder 10 and a card issuer 11. A card holder 10 is typically an individual who makes a contract with the card issuer 11 and, by receiving the credit card, accepts liability of the operations made with the credit card, as long as they are implemented according to the terms of the contract. The card holder 10 may own the card directly or be authorized to utilize the card for another party, for example an organization, a company or the like. However, the card holder 10 essentially has the final power to authorize the operations made with the credit card, and thereby also carries the responsibility of the financial consequences resulting from the operations. Typically a card holder 10 opens with the card issuer 11 an account, which is a record of debit and credit entries to cover transactions involving the card holder 10.

The card issuer 11 is a party that, on the basis of the established contractual relationship, assures that sellers receive a payment for the merchandise purchased with the credit card. On the other hand, the card issuer 11 also bills the card holder 10 for the charges made with the credit card.

The credit card corresponds with one contract between the card holder 10 and the issuer 11. A contract in this context thus refers to a complete agreement on financial liability in respect of defined identification means between the card issuer 11 and the card holder 10. One contract may thus comprise one or more settlement variations, which the card holder 10 may choose when he or she accepts the payment. For example, a card holder may, at paying, choose whether to use his or her card for payments that are more or less immediately charged from the account, or for credit payments where the charging is deferred to a defined date later on. One contract may also provide the user to acquire one or more physical plastic cards, for example one primary and one or more secondary cards. All such variations that follow the one contractual line of responsibility are thus included in the scope of protection, even if not specifically mentioned at each time further on.

Nowadays, the identification means are typically implemented with a plastic card to which identification information is permanently attached. For example, in a typical current credit card the credit card identity is embossed to the plastic material of the card and, in addition, the plastic card also carries a magnetic stripe to which information is stored in electronic form. Typically the embossed information and the information in the magnetic stripe correspond with each other, i.e. comprise the same credit card identity.

The credit card enables obtaining goods or services and the provider of them can trust that payment will be made. Such provider in this context is referred to as a card accepter 12. The card accepter 12 may be an individual, an organization, a corporation, or any party that has a capability to identify the credit card, and implement the payment such that the money is eventually transferred from the card holder 11 to the card accepter 12. In these days, the money is most often transferred from the account of the card holder 10 to the account of the card accepter 12.

Typically card accepters 12 do not have to make separate contracts with card issuers and implement separate procedures for different types of credit cards, but have a contractual agreement with at least one acquirer 13 that acquires credit card authorization requests from card accepters and provides guarantees of payment. Typically one acquirer is capable of operating with several issuers and offers a broad range of services for the card accepters.

Interface in this context refers to a combination of a physical boundary and a set of agreed protocols to be used in communication over that boundary. The common boundary (interface) IF1 14 between the card holder 10 and the card accepter 12 is very flexible. The card holder and the card accepter may quite freely choose the way in which the credit card identity is delivered to the card accepter 12, typically this is set by the card accepter 12. The most typical case is online payment made over the Internet, but within the scope of protection the credit card identity may be submitted by means of any type of network, using card readers or not, verbally with or without a phone, as long as the credit card identity gets transferred to the card accepter and may be connected to a defined credit card operation.

The interface IF2 between the card accepter 12 and the acquirer 13 is more secured than IF1, but available to numerous parties and is typically contracted with the mutual agreement between the card accepter 12 and the acquirer 13. Typically the interface comprises a set of protocols defined by the acquirer 13 and is accessed by the card accepters 12 through various types of network connections.

In order to provide guarantees of payment, the acquirer 13 has a contractual relationship with at least one transaction operator 16. A transaction operator 16 represents here an entity that operates a closed and strictly secured communication network, a transaction network, that routes transaction messages between acquirers 13, and card issuers 11 worldwide. Examples of such transaction networks comprise VisaNet for Visa cards, Global Payment Systems of MasterCard, Discover Network for Discover credit cards, and Payflow processing platform through VeriSign Payment Services for American Express.

An acquirer 13 may interface one transaction network or a number of transaction networks, each of which may provide a separate interface towards the acquirer. The transaction operator 16 of FIG. 1 may thus represent one operator that provides one interface IF3 for the communication with the acquirer, or a cluster of operators whose various subinterfaces form the aggregate interface IF3. Correspondingly, the card issuer 11 may be contacted through one transaction network, or a number of transaction networks, each of which may provide a separate interface towards the card issuer. The transaction operator 16 of FIG. 1 may thus represent one operator that provides one interface IF4 for the communication with the card issuer, or a cluster of operators whose various subinterfaces form the aggregate interface IF4.

The interfaces IF3 and IF4 of the transaction operator are closed, highly secured and strictly specified. The communication over these interfaces takes place by means of formal statements of adopted procedures, also called as protocols. After a coordinated work of the American National Standards Institute (ANSI) and the International Organisation for Standardisation (ISO), as well as several other involved parties, a collection of standards and de facto standards nowadays specify formats for exchanging messages between the parties, as well as functions for authorization and security. Due to the incredible number of involved parties and installed base all over the world, it is clear that any changes to the existing specifications between the card accepters, acquirers, and issuers between are practically impossible.

According to the invention, the embodiment of FIG. 1 additionally shows a service provider 19 that has two roles towards the transaction operator 16. The service provider 19 provides towards the transaction operator 16 interfaces IF3 and IF4. The transaction operator 16 may thus exchange authorization requests and responses with the service provider 19 through an issuer interface IF4 like with another card issuer. In addition, the transaction operator may 16 may exchange authorization requests and responses with the service provider 19 through an acquirer interface IF3 like with another card acquirer. Depending on the application, interfaces IF3 and IF4 may be implemented together such that an entity is able to communicate with the transaction operator over one connection or session in different roles, for example, as an acquirer or an issuer. Interfaces IF3 and IF4 may also be implemented separately such that a new connection needs to be established when a different role is assumed by an entity. Both these variations are possible under the claimed scope of the protection.

Furthermore, the service provider 19 offers towards the card holder 10 an authorization interface IF5 191 for separate authorization of individual credit card operations of the card holder. Preferably, the service provider 19 provides towards the card holder also a user interface IF6 192 that allows viewing and managing of the credit card operations that the card holder 10 performes through the service provider 19. The operation of the service provider 19 and the configuration of the authorization interface 191 and the user interface 192 are described in more detail in this specification.

FIG. 2 illustrates an exemplary network configuration for implementing the embodiment of FIG. 1. As a first interface IF1 for providing the credit card identification information, in the embodiment of FIG. 2 the card holder 200 utlizes a terminal 202 that is connected to the Internet 250. Internet refers here to a global open information network which consists of interconnected computers that transmit data using a standardized Internet Protocol (IP). Through Internet 250 the credit card holder 200 can access webpages and display them in the user interface of the personal computer 202. Through a webpage of a merchant the credit card holder may view the items on sale, and after choosing an appropriate product may click a hypertext link for payment services. This way he or she gets connected with a network element that runs a payment processing application of the merchant. Depending on the implementation, this application may exist on a separate payment processing system 220 of the merchant or may be a shared system for a group of online shops. A payment processing system may be implemented by means of a network communication enabled computer device in a manner well known to a person skilled in the art.

The payment processing system 220 has a network connection, for example, a private network connection over the Internet 250 to an network element that runs the acquirer service, herein called as an acquirer system 230. The acquirer system 230 is further connected to a secure transaction network 260 that connects acquirer systems 230, and card issuer systems 210 all over the world. An acquirer system 230 may be implemented by means of a network communication enabled computer device in a manner well known to a person skilled in the art.

Typically the network infrastructure of the transaction network 260 comprises a multiplicity of mainframe computers and mid-range systems. It should be noted that the Internet 250 and the transaction network 260 illustrate herein logical elements of the system architecture, without creating restrictions to interpretation on the configuration of individual subnetworks or network elements. For a person skilled in the art it is clear, for example, that a network element may or may not be connected to the Internet 250 and to the transaction network 260 without deviating from the scope of protection. The utmost priority of the transaction network 260 is security, and thus the interfaces of the transaction network 260 are not open for individual credit card holders.

According to the invention, the service provider 240 connects to the transaction network 260 through a network element, in this embodiment shown as an application server 242. The application server 242 comprises the functionality to provide towards the transaction network the end of the issuer interface that enables communication between a card issuer and the transaction operator, and of the acquirer interface that enables communication between the acquirer and the transaction operator. The network connection of FIG. 2 towards the transaction network thus acts as a physical boundary for interfaces 17 and 18 of FIG. 1. In addition to this, the application server 242 is further connected to an authorization network that offers a path for individual authorization of a payment request between the application server 240 and the credit card holder 200.

In FIG. 2, the authorization network is primarily illustrated by a public land mobile network (PLMN). A public land mobile network (PLMN) infrastructure of FIG. 2 is logically divided into core network 270 and access network 280 infrastructures. The access network may refer to, for example, a base station subsystem for a GSM or radio network subsystem for third generation mobile communications system. The core network is logically divided into a circuit switched domain, a packet switched domain and an IP multimedia subsystem. The circuit switched domain refers to a set of core network entities offering a circuit switched type of connection for user traffic as well as all the entities supporting the related signalling. A circuit switched type of connection is a connection for which dedicated network resources are allocated upon connection establishment and released upon connection release, for example a voice call. A packet switched type of connection, on the other hand, transports user information using packets so that each packet can be routed independently from a previous one. Examples of the packet switched domain include the GPRS (General Packet Radio Service), whereby typical entities of the core network include a serving GPRS support node (SGSN) and a gateway GPRS support node (GGSN).

In the embodiment of FIG. 2, the mobile switching network offers an authorization path between the service provider 240 and the credit card holder 200. Through the mobile switching network the application server 242 may deliver different types of messages to the mobile station 204 of the credit card holder 200, for example short messages. The core network 280 of the mobile switching network may also comprise an IP multimedia subsystem for provision of multimedia services. The IP multimedia subsystem IMS utilizes the PS domain to transport multimedia signalling and bearer traffic. Thus the authorization path may alternatively be implemented as a session initiation protocol (SIP) session over an active packet data protocol (PDP) context of the credit card holder 200. A further option for implementing the authorization path is provided by a user terminal 244 managed by the service provider. The user terminal 244 offers possibility for a person-to-person voice call authorization between an operator of the service provider and the credit card holder. In FIG. 2, the user terminal 244 is illustrated as a mobile station. However, any type of user terminal capable of voice communication is applicable in this context.

It should be noted that only elements necessary for disclosing the invention are illustrated herein. Implementation of communication connections between the different disclosed network elements is well known to a person skilled in the art, and will not be disclosed in more detail herein.

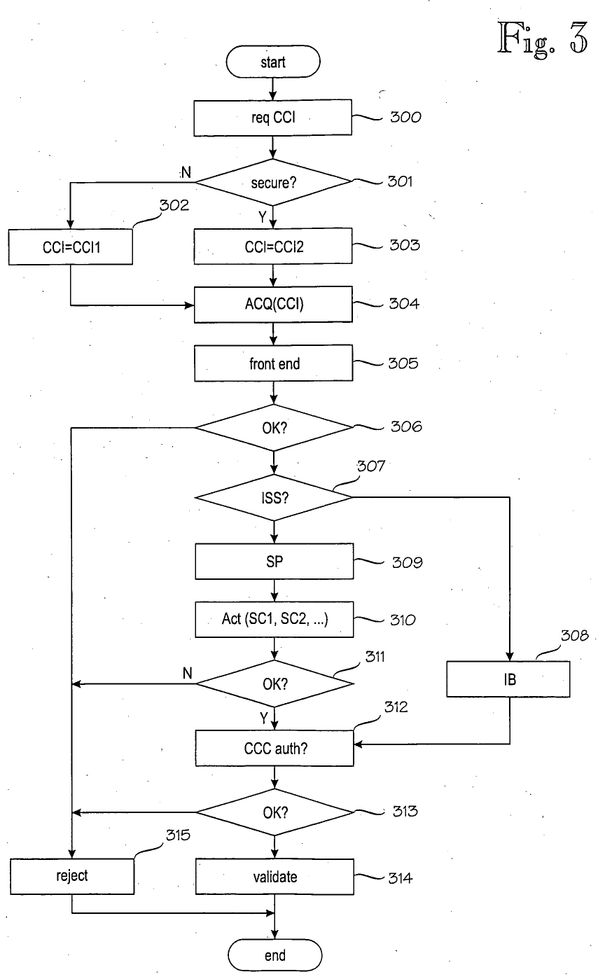

In the following, the operation of the embodied system of FIGS. 1 and 2 is disclosed in general level with reference to FIG. 3. The flow chart of FIG. 3 illustrates a procedure for validating or rejecting an authorization request by the card accepter. As discussed earlier, the procedure begins when the credit card holder has chosen merchandise through the Internet, and in order to make the payment, has connected to a payment processing application of the merchant. In step 300 the credit card holder receives a request for submitting his or her credit card identity for charging. In a conventional solution, the credit card holder has a first contract with an issuing bank and the acquirer, and he or she has been assigned a unique first credit card identity that corresponds with the first contract. The credit card identity is permanently attached to the physical credit card by, for example, imprinting, embossing, and/or in a magnetic stripe.

In the embodiment according to the invention, the credit card holder has also a second contract with the service provider and the issuing bank, and he has been assigned a unique second credit card identity that corresponds with the second contract. It should be noted that the existence of the first contract is preferred, but not mandatory. Solutions where the user utilizes the credit card only for payments over the Internet, and the bills are charged separately also belong to the scope of protection of the present invention.

In the case of the embodied example, in step 301 the user chooses whether to submit to the payment processing system the first credit card identity or the second credit card identity. By submitting the first credit card identity CCI1 (step 302) the credit card holder enters the conventional procedure and thereby accepts the conventional security level and lesser visibility to the payment procedure. This may be acceptable if, for example, the merchant is well known and the sum is very small.

By submitting the second credit card identity CCI2 (step 303) the credit card holder enters a modified procedure that provides enhanced security and user interaction. It should be noted that only steps essential for understanding the invention are disclosed herein. For a person skilled in the art it is clear that within the scope of protection the payment procedure may and most likely will comprise several elements and stages that are not explicitly disclosed herein. For example, typically some additional information is requested from the credit card holder, for example, the expiry date and various card security codes and/or card verification values.

The payment processing system may make some preliminarily checks on the credit card identity. After these, the payment processing system creates an authorization request message according to the protocol agreed to be followed in the interface between the card accepter and the acquirer, and transmits the message to the acquirer (step 304). The message comprises the essential details of the payment under validation, for example the credit card identity (also called as a personal account number, PAN), the merchant ID, purchase amount, etc.

The acquirer is typically authorized by the issuers to make some front end screening (step 305) of the provided details. Such checks comprise, for example, check for valid merchant ID, valid Luhn check on PAN, expiration date not past, amount within reason for type of merchant, etc. An authorization request that during screening (step 306) fails one or more checks may be rejected already by the acquirer (step 315). A payment transaction that pass the front end checks is routed on the basis of the information in the credit card number (PAN) to a defined issuer (step 307). In case the submitted credit card identity was the first credit card identity CCI1, the transaction authorization request will be forwarded conventionally through the transaction network towards the credit card issuer (step 308), for example the issuing bank. In case the submitted credit card identity was the second credit card identity CCI2, the transaction authorization request will be forwarded towards the service provider (step 309).

In establishing the new service, the service provider assumes at least two different roles. To the direction of the acquirer, the service provider looks like a card issuer and receives messages according to the protocol of the issuer interface. The authorization requests are routed to the service provider in a conventional manner, presently according to the first six digits of the PAN. The service provider implements a group of authorization and recording operations (steps 310, 311) on the basis of an individual agreement made with the credit card holder. These operations will be discussed in more detail later in this document. As a result of the operations, the service provider either rejects the request (step 307), for example by submitting a rejection message acting as the card issuer. Alternatively, the service provider continues the authorization procedure (step 312) by sending an authorization request based on the original authorization request towards the true issuer (step 308) of the credit card, i.e. the issuer that eventually charges the payment from the user.

In order to be able to implement authorization requests with the true issuer, the service provider has been allocated an acquirer identity and an accepter identity. When the service provider needs to authorize the payment, the second credit card identity CCI2 in the original authorization request is replaced by the first credit card identity CCI1, the original acquirer identity is replaced by the acquirer identity of the service provider, and the original accepter identity is replaced by the accepter identity of the service provider.

The authorization request by the service provider is routed in the transaction network to the true issuer according to the first credit card identity CCI1, and the response is routed back to the service provider according to the acquirer identity of the service provider. In the issuers record the transaction is shown as a transaction of the service provider. The arrangement provides a secure arrangement whereby the service provider can permissibly intercept an authorization request in order to enhance the security and visibility of the credit card transaction. No specific tailoring in order to implement the arrangement is required from the card accepter, the acquirer, or the card issuer.

In case the authorization by the true issuer is successful, the service provider, acting as an issuer, submits a message that validates the payment to the original acquirer (step 314), who forwards it to the original card accepter. Through a validation the issuer basically confirms that it has checked a transaction related to a specific contract, finds the transaction to fulfil the terms of the contract, and will perform the actions as agreed in the contract. At the same time the financial liability of the transaction is transferred to the issuer, again according to the terms and conditions of the contracts between the parties involved. In the embodied case the financial liability is transferred from the original accepter to the service provider and directly all the way to the true issuer so that the intended chain of liability is not interfered with.

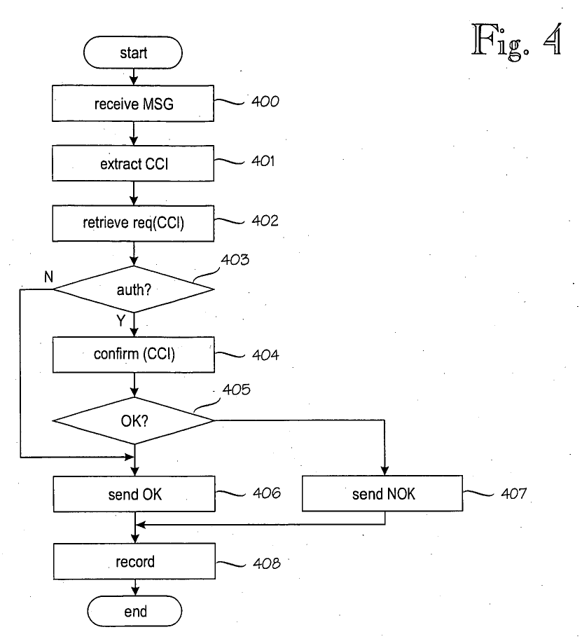

The operation by the service provider is disclosed in more detail with reference to the flow chart of FIG. 4. As discussed above, the service provider manages a database that comprises a registry for information on credit card holders that have made a service contract with the service provider. A record of the registry corresponds to a virtual account established for the credit card holder, and primarily comprises the control data required for implementing the service. Such control data typically corresponds to the data stored with a conventional credit card account. The control data identifies, for example, the credit hard holder, the relevant contracts, the addressing information for specific transaction confirmation procedures, and service conditions according to which the service provider adjusts the service for the specific virtual account. A service condition may be implemented, for example, by means of a parameter, a variable whose value affects the operation of the service provider. A control data record may thus comprise, for example, the following fields:

<First name>
<Last name>
<Address>
<Social security number>
<1^{st} credit card identity>
<2^{nd} credit card identity>
<1^{st} confirmation address>
<2^{nd} confirmation address>
<1^{st} service condition>
<2^{nd} service condition>
...

In addition, the database also comprises a number of transaction records comprising information stored in connection with activities of the credit card holder. The control data may be used to control also the actions related to storing of the information. A transaction record may thus comprise, for example, the following fields:

<Timestamp of request>
<Acquirer>
<Card accepter>
<Sum>
<Timestamp of transaction confirmation>
<Confirmation address >
<Timestamp of confirmation response>
<...>

The above control data and transaction data fields are provided as an example only. Several different types of data structures may be utilized within the scope of protection of the present invention.

In step 400 the service provider receives from the acquirer an authorization message MSG. The message originates from the original acquirer and has been routed to the service provider according to the second credit card identity CCI2, as described above. The service provider extracts (step 401) from the message the second credit card identity CCI2, and retrieves (step 402) the control data record Req(CCI2) that corresponds with said second credit card identity CCI2. On the basis of the control data in the control data record Req(CCI2) the service provider decides (step 403) whether a transaction confirmation should be implemented or not.

As discussed above, the service provider has an interface for transaction confirmation messages, which may be sent to customers when a virtual credit card authorization request is received. The user confirmation process is not restricted to any specific method, but comprises a mechanism that allows the user to indicate his or her willingness to let the normal authorization of the transaction continue. The basic method for confirmation employs mobile phones and short messages. The 1^{st} confirmation address in the record is the MSISDN of the credit card holder. When user confirmation is required, the system sends, according to a service condition in the record, a short message with the payment details to the 1^{st} confirmation address. For example, regular short messages, multimedia messages or type 0 messages are applicable herein.

When the message arrives to the customer's mobile phone, the credit card holder may check the details of the transaction. If he or she considers the transaction valid, the credit card holder may reply to the message with an agreed keyword or a passcode, and the service provider will continue the authorization procedure. If the credit card holder does not consider the transaction valid, the user may send a keyword that denies the transaction, and the authorization procedure is terminated, and the request is rejected by the service provider. As an additional an expeditious security measure, a certain keyword may be arranged to suspend the virtual credit card, which immediately makes any further attempts to misuse the second credit card identity quite impossible.

For a person skilled in the art it is clear, the transaction-specific confirmation may be implemented in various ways without deviating from the scope of protection.

When the time between receiving a virtual credit card authorization request and the user confirmation is critical, it is advantageous to use a mobile station application. The credit card holder may launch an application in the mobile station prior to the credit card purchase, and a connection will be established between the mobile station and the application server of the service provider through a mobile phone network. When the service provider receives the authorization request for the credit purchase, it forwards a notification to the mobile station application. In response to this, the application presents in the display of the mobile station the transaction details. The user may be given options to accept or deny the transaction. If the user has chosen to use passcode authentication, a passcode field is given. The credit card holder inputs the answer, and the mobile station application sends it to the service provider, where it is processed and the credit card transaction is handled accordingly.

A voice recognition confirmation utilizes voice calls and it is therefore applicable with mobile phones as well as with fixed phones. In voice recognition confirmation, when an authorization request is received, the voice recognition system is arranged to place a call to the user's phone. When a connection is established, the system prompts the user with details of the transaction underway, and the user accepts or denies the transaction by pressing the keypad on the phone.

For enhanced security, the user can select a one-time password confirmation. The one time password confirmation is based on a list of passwords that can be used only once. During confirmation, the user is advised to enter the next unused password and the input is compared with the system database holding the passwords and information of passwords already used. The one time password confirmation can be used to enhance any of the exemplary confirmation methods disclosed herein.

Another method of further improving the security of the delivery of the confirmation message, digital certificate confirmation may be used. Digital certificate confirmation uses cryptographic functions and a certificate issued to the user to authenticate the confirmation message. If the user accepts the transaction, the transaction information is digitally signed with a public key cryptographic function and sent to the service provider. The service provider checks the validity of the signature and if it valid, the confirmation is considered authentic.

The one time password or digital certificate authentication can be implemented in co-operation with a third party who holds the authentication information. The user input is forwarded to the authenticating party who responds whether the confirmation information was valid.

The above mechanisms are, as such, generally known to a person skilled in the art, and their implementation will not be discussed in more detail herein.

After the confirmation is made (step 404) and the response from the credit card holder for the transaction is received, the service provider checks (step 405) the answer. If the answer is positive, the service provider continues processing the authorization request (step 406) by mapping the request details, as described above, to a credit card authorization request addressed to the true issuer, typically the issuer of the first credit card identity CCI1. If the answer by the true issuer is negative, the service provider generates a rejection and returns it to the acquirer. In either case, the service provider generates a transaction record (step 408) on the procedure and stores it in the database.

The above transaction confirmation procedure improves the credit card payment system significantly by allowing the user to participate the authorization process after the stage where the most risks typically take place, or at least are envisioned, i.e. after the payment request by the card accepter. In addition, the account control data facilitates provision of a user interface and offers the credit card holder a completely new way to control and manage his or her credit card operations. This user interface can be provided as a normal client-server-configuration over the Interface without violating or disturbing any of the highly secured procedures currently followed by the other parties of the authorization procedure, i.e. merchants, acquirers and banks.

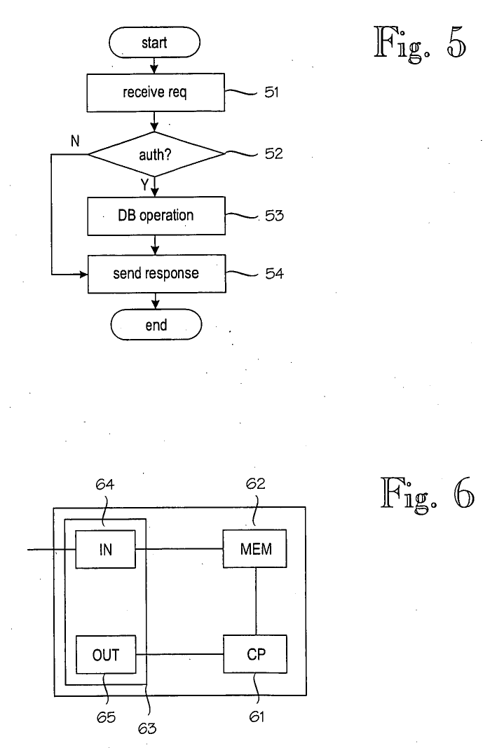

FIG. 5 illustrates the functions of the service provider when it operates as a user interface. In step 50, the service provider receives from a credit card holder a request for a database operation. Typically this request arrives over the Internet, and comprises a username and password provided by the credit card holder in relevant fields in a webpage of the service provider. Other means are naturally possible within the scope of protection, for example telephone calls, fax messages, and various types of text and multimedia messaging may be applied herein. When the service provider receives the request, it authenticates the user, and checks that the request is valid (step 51). The request may define any type of database action, or a combination of actions. Examples of such comprise an inquiry of defined data, request for retrieving defined data for viewing by the credit card holder, command to cancel a possibly compromised credit card identity and application of a new one, request to amend the personal identification data, request to change a parameter in the service conditions, etc. If the result of the check is negative, the request is denied and a response with an error message is transmitted to the credit card holder (step 53). Otherwise, the requested action is implemented (step 52) and a response with acknowledgement of the completed action is transmitted to the credit card holder (step 53). This type of visibility and control to the credit card actions has not been available to the credit card users.

The above steps of operations by the service provider disclosed above may be implemented by various types of computer devices that allow connection to a communication network for exchange of information. Such computer devices comprise, for example, application servers, personal computers, and mainframe computers.

In the following, an exemplary configuration for implementation of the disclosed embodiment of the invention is given. Reference is made to FIG. 6 that comprises a functional description of elements of a network element implementing the functionality of the application server of the service provider, as disclosed above. The application server comprises processing means 61, an element that comprises an arithmetic logic unit, a number of special registers and control circuits. Connected to the processing means are memory means 62, a data medium where computer-readable data or programs or user data can be stored. The memory means typically comprise memory units that allow both reading and writing (RAM), and a memory whose contents can only be read (ROM). The unit also comprises an interface block 63 with input means 64 for inputting data for internal processing in the unit, and output means 65 for outputting data from the internal processes of the unit. Examples of said input means comprise a plug-in unit acting as a gateway for information delivered to its external connection points. For receiving information on the operator of the application server, the application server may also comprise a keypad, or a touch screen, a microphone, or the like. Examples of said output means include a plug-in unit feeding information to the lines connected to its external connection points. For outputting information to the operator of the application server, they may also comprise a screen, a touch screen, a loudspeaker, or the like. The processing means 61, memory means 62, and interface block 63 are electrically interconnected for performing systematic execution of operations on the received and/or stored data according to the predefined, essentially programmed processes of the unit. In solutions according to the invention, the operations comprise functions for implementing the operations and interfaces of the application server as described above in FIGS. 3, 4, and 5.

It will be obvious to a person skilled in the art that, as the technology advances, the inventive concept can be implemented in various ways. The invention and its embodiments are not limited to the examples described above but may vary within the scope of the claims.

1. A credit card payment system, comprising
a credit card associated with a first credit card identity of a credit card holder;
a payment network comprising:
means for receiving an authorization request comprising the first credit card identity;
means for identifying a network element associated with the first credit card identity in the received authorization request; and
means for routing the received authorization request to the identified network element;
the network element comprising:
a record of individual credit card control information defining a credit card control procedure for the associated first credit card identity, and
a user interface accessible to the credit card holder of the first credit card identity and configured to provide the credit card holder with access to the individual credit card control information.

2. A credit card payment system according to claim 1, wherein the credit card is associated with a second credit card identity of the same credit card holder;
the credit card control procedure of the network element comprises a transaction confirmation procedure for the associated first credit card identity;
the user interface allows the credit card holder to control the operation of the credit card control procedure;
when in operation, said transaction confirmation procedure causes the network element to:
in response to receiving the authorization request comprising the first credit card identity, generate a transaction confirmation message on the basis of the information in the authorization request;
send the transaction confirmation message to the credit card holder;
in response to receiving a positive confirmation from the credit card holder, generate a new authorization message comprising the second credit card identity and at least part of the information in the authorization request.

3. A credit card payment system according to claim 2, wherein the network element is configured to deliver the transaction confirmation message to the credit card holder by at least one of the following ways: a short message, a multimedia message, voice call, IP session.

4. A credit card payment system according to claim 2, wherein the delivery of the transaction message is protected by at least one of the following methods: password authentication, one time password authentication, digital certificate authentication, authentication by third party credentials.

5. A credit card payment system according to claim 2, wherein
when in operation, said transaction confirmation procedure is configured to cause the network element to generate a record on the actions performed during the credit card control procedure of the associated first credit card identity; the user interface is configured to provide the credit card holder with a view to said record.

6. A method of conducting credit card payments, comprising
associating a credit card with a first credit card identity of a credit card holder;
storing in a network element of a payment network a record of individual credit card control information defining a credit card control procedure for the associated first credit card identity, and
routing received authorization requests comprising the first credit card identity to the network element;
providing a user interface accessible to the credit card holder of the first credit card identity, configured to provide the credit card holder with access to the individual credit card control information.

7. A method according to claim 6, further comprising
associating the credit card with a second credit card identity of the same credit card holder;
including in the credit card control procedure of the network element a transaction confirmation procedure for the associated first credit card identity;
allowing the credit card holder to control the operation of the credit card control procedure;
in response to receiving the authorization request comprising the first credit card identity, generating a transaction confirmation message on the basis of the information in the authorization request;
sending the transaction confirmation message to the credit card holder; and
in response to receiving a positive confirmation from the credit card holder, generating a new authorization message comprising the second credit card identity and at least part of the information in the authorization.

8. A method according to claim 6, further comprising: delivering the transaction confirmation message to the credit card holder by at least one of the following ways: a short message, a multimedia message, voice call, IP session.

9. A method according to claim 6, further comprising: protecting the delivery of the transaction message by at least one of the following methods: password authentication, one time password authentication, digital certificate authentication, authentication by third party credentials.

10. A method according to claim 6, further comprising:
generating a record on the actions performed during the credit card control procedure of the associated first credit card identity;
providing the credit card holder with a view to said record through the user interface.

11. A network element for a credit card payment system, said system comprising
a credit card associated with a first credit card identity of a credit card holder, and
a payment network comprising:
means for receiving an authorization request comprising the first credit card identity;
means for identifying a network element associated with the first credit card identity in the received authorization request; and
means for routing the received authorization request to the identified network element;
the network element comprising:
a record of individual credit card control information defining a credit card control procedure for the associated first credit card identity, and
a user interface accessible to the credit card holder of the first credit card identity and configured to provide the credit card holder with access to the individual credit card control information.

12. A network element according to claim 11, wherein the credit card is associated with a second credit card identity of the same credit card holder;
the credit card control procedure of the network element comprises a transaction confirmation procedure for the associated first credit card identity;
the user interface allows the credit card holder to control the operation of the credit card control procedure;
when in operation, said transaction confirmation procedure causes the network element to:
in response to receiving the authorization request comprising the first credit card identity, generate a transaction confirmation message on the basis of the information in the authorization request;
send the transaction confirmation message to the credit card holder;
in response to receiving a positive confirmation from the credit card holder, generate a new authorization message comprising the second credit card identity and at least part of the information in the authorization request.

13. A network element according to claim 11, wherein the network element is configured to deliver the transaction confirmation message to the credit card holder by at least one of the following ways: a short message, a multimedia message, voice call, IP session.

14. A network element according to claim 11, wherein the delivery of the transaction message is protected by at least one of the following methods: password authentication, one time password authentication, digital certificate authentication, authentication by third party credentials.

15. A network element according to claim 11, wherein when in operation, said transaction confirmation procedure is configured to cause the network element to generate a record on the actions performed during the credit card control procedure of the associated first credit card identity;
the user interface is configured to provide the credit card holder with a view to said record.

16. A computer program product, executable in a network element, wherein execution of the computer program product in the network element causes the network element to store a record of individual credit card control information defining a credit card control procedure for each associated first credit card identity,
receive authorization requests comprising the first credit card identity;
provide through a user interface accessible to the credit card holder of the first credit card identity, the user with access to the individual credit card control information.

17. A method of providing credit card payment service, comprising
arranging access to a credit card payment network such that authorization requests comprising one or more defined first credit card identities are routed to a network element operated by the service provider;
storing a record of individual credit card control information defining a credit card control procedure for the associated first credit card identities,
providing a user interface accessible to credit card holders of the defined card identities, the user interface allowing the credit card holder with access to the individual credit card control information.

18. A method according to claim 17, further comprising:
associating the first credit card identities with second credit card identities of another party in the credit card payment system;
in response to receiving the authorization request comprising the first credit card identity, generate a transaction confirmation message on the basis of the information in the authorization request;
sending the transaction confirmation message to the credit card holder; and
in response to receiving a positive confirmation from the credit card holder, generate a new authorization message comprising the second credit card identity and at least part of the information in the authorization;
sending the new authorization message to the other party in the credit card payment system.

19. A method according to claim 18, wherein the other party of the payment system is an issuing bank of the credit card.

20. A method according to claim 17, further comprising:
generating records on the actions performed during the credit card control procedures of the associated first credit card identities;
providing, through the user interface, the credit card holder with a view to said record.

21. A credit card payment system according to claim 3, wherein the delivery of the transaction message is protected by at least one of the following methods: password authentication, one time password authentication, digital certificate authentication, authentication by third party credentials.
